(19) United States
(12) Patent Application Publication
(10) Pub. No.: US 2008/0262898 A1
(43) Pub. Date: Oct. 23, 2008

(54) Method For Measuring The Overall Operational Performance Of Hydrocarbon Facilities

(76) Inventors: Angel D. Tonchev, Santa Barbara, CA (US); Christo D. Tonchev, Santa Barbara, CA (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/791,895

(22) PCT Filed: Dec. 9, 2005
(86) PCT No.: PCT/US2005/044659

§ 371 Date: Mar. 10, 2008

Related U.S. Application Data
(60) Provisional application No. 60/635,056, filed on Dec. 9, 2004.

(51) Int. Cl. G06Q 99/00

(52) U.S. Cl. 705/10

(57) ABSTRACT

A method, named Juran Hydrocarbons Index (JHI), for measuring the overall competitiveness of an oil and gas facility (i.e. platform, pipeline, marine terminal, processing terminal, refinery, or LNG plant) that incorporates operational efficiency and effectiveness. The method describes a plurality of performance metrics that reflect measurable properties of an oil & gas organization. It further calculates the percentage deviation of these metrics relative to the corresponding industry or peer group average and assins weights of importance in the form of gap cofficients. Finally, it integrates all the individual performances into a mathematical equation to provide a numerical value (an index) of overall hydrocarbons competitiveness.

### CROSS REFERENCE TO RELATED APPLICATION

This application claims the benefit of U.S. Provisional Application Ser. No. 60/635,056 filed on Dec. 9, 2004.

### TECHNICAL FIELD OF THE INVENTION

The present invention relates to business process measurement and benchmarking methods and, more precisely, a method for measuring the operational performance of oil and gas facilities. The invention is applicable throughout the entire hydrocarbon value chain.

### BACKGROUND OF THE INVENTION

Since the inception of the first competitive benchmarking study, initiated by Xerox Corp. in the late 1970′s, and the following academic work of Robert C. Camp (Camp, 1989), up until today the benchmarking methods have continually evolved. The oil and gas industry has witnessed this development through the introduction of new approaches to benchmarking, wider variety of performance metrics, and different normalization procedures, all aiming to provide a more accurate and informative picture of performance. Despite this progress, the industry has lacked a consistent and scientifically sound methodology for measuring overall operational performance. The outcomes of most benchmarking exercises have been a collection of key performance indicators (KPIs), identification of gaps for improvement, and recommendations based upon these gaps. However, most of these practices have failed to recognize the significance of interdependencies between metrics.

In addition, many of the benchmarking tools currently employed lack accuracy and offer only a partial picture of competitiveness. For example, most managers evaluate the performance of their oil and gas assets on the basis of the gap analysis, even though its purpose is to indicate improvement potential. The reason for this is that the majority of the benchmarking studies concentrate their attention predominately on one reference point, the best industry performer. This reference point may not be the most appropriate measure of performance. It reflects the performance of only one benchmarked asset (or at most a few), whose value may not be representative of the industry. In contrast, the performance can be measured relative to the industry average. This point is statistically more reliable because it considers the values of all participants and minimizes the effects of the outliers.

Similarly, the radar chart, a tool commonly used in benchmarking studies, reflects only the quartile distribution of the performance metrics. Whilst it provides a good visual presentation of performance in different business areas, it is unable to indicate actual overall competitiveness. This is because it transforms variable data into discrete output by applying ranking techniques. As a result, the radar chart is incapable of precisely determining how much better or worse an individual performance is.

Given these limitations, there would appear to be a need for a methodology that provides a precise and accurate measurement. In particular, a need for an industry index of operational performance that can be applied consistently throughout oil and gas industry, irrespective of the asset type being studied.

### SUMMARY OF THE INVENTION

The present invention addresses the needs of the hydrocarbons industry in providing a method of precise measurement of operational performance. It overcomes limitations associated with prior industry approaches to organizational performance, efficiency and effectiveness monitoring, and control.

The invention is a cumulative indicator (an index) of the overall company's competitiveness measured by the percentage deviation from the corresponding industry or peer group average. The index is built around a balanced model that is achieved by assigning equally all key performance indicators to efficiency and effectiveness variables. Statistically speaking, this implies that both types of variables have equal influence on the overall result, ceteris paribus. In addition, all cost and hour metrics are paired providing a balanced and a more precise estimation of efficiency. Further, the JHI applies two types of normalization: complexity (most performance metrics of an individual facility are normalized by its corresponding complexity factor, allowing “like for like” comparisons of performance indicators of business processes which at first glance may appear too dissimilar for any valid comparison to be made) and mathematical (all measures are transformed in identical units (%)). Finally, the index is decomposable to its building blocks to provide more detailed performance data.

A technical advantage of the present invention is that it allows monitoring of the performance of an oil & gas facility. The Index score and decomposition provide an assessment of the facility's overall performance and a clear and unambiguous identification of its strengths and areas of non-competitiveness. In addition, the Index helps to inform the balance between efficiency and effectiveness initiatives and may benefit managers by providing a tool for resource allocation.

Another technical advantage of the present invention is that it is applicable throughout the entire hydrocarbons value chain. The resultant overview of operational performance across the entire asset base is of obvious benefit to Senior Management. Scores can provide an indication of performance per business area and asset type, thereby offering significant insight into asset performance and enhancing the monitoring and control of operations at a corporate level. This will in turn input to improvement initiatives by identifying the problematic areas, highlighting the best practices within and external to the organization and indicating appropriate training requirements.

Yet a further technical advantage of the present invention is that it allows more accurate and reliable measurement. In particular, the index uses the industry average value as a reference point rather than the best performer value, eliminating the effects of the outliers. It also measures the competitiveness in exact terms (percentage deviation), allowing managers to precisely determine how good or bad their operations are.

Still another technical advantage of the present invention lies in its application to longitudinal analyses to assess industry performance year upon year based upon changes in industry averages. Clearly, the potential beneficiaries of such any analysis include a wider spectrum of professionals within the oil and gas industry.

It has been found that the foregoing and related advantages can be readily attained in a method for measuring overall performance of hydrocarbons operations in a single numerical index to determine whether to make alterations to the hydrocarbons operations comprising the steps of:
(a) providing an industry average;
(b) calculating a single numerical index which is an aggregation of the effectiveness and efficiency of the hydrocarbons operations based on percentage deviation from the industry average; and
(c) altering the hydrocarbons operations based on the single numerical index to increase overall performance thereof.

During the calculating step, a plurality of effectiveness and efficiency variables are used for a specific hydrocarbons industry. Desirably, a balance is achieved between the effectiveness and efficiency variables.

According to the invention, the method further comprises the step of computing gap coefficients used during the calculating step. The gap coefficients are used to determine gap direction, ensure a balance between efficiency and effectiveness and assign a weight of importance to individual performance measurements.

### BRIEF DESCRIPTION OF THE DRAWINGS

The invention with its main components is best understood when read in conjunction with the following drawings:

FIG. 1 is a chart of Index Structure—which provides a high-level structure of the index composition and division between efficiency and effectiveness metrics;

FIG. 2 is an illustration of the formula for Index Calculation—which provides a mathematical equation of the index;

FIG. 3 is an illustration of the formula for Gap Coefficients—which provides exact calculations of the gap coefficients;

FIG. 4 is an illustration of Performance Matrix—which illustrates graphically the overall facility performance relative to the efficiency and effectiveness parts of the index computation;

FIG. 5 is an illustration of Index Decomposition—which provides performance information for each metric that takes part in the index;

FIG. 6 is a chart of Industry Performance—International Consortium of Processing Terminals—which provides industry example;

FIG. 7 is an illustration of JHI Trend Analysis—International Consortium of Processing Terminals—which provides industry example;

FIG. 8 is a chart of Annual Average Values—International Consortium of Processing Terminals—which provides industry/computation example;

FIG. 9 is a chart of Weight Factors—International Consortium of Processing Terminals—which provides industry/computation example; and

FIG. 10 is a chart of Gap Coefficients—International Consortium of Processing Terminals—which provides industry/computation example.

### DETAILED DESCRIPTION OF THE INVENTION

The invention (JHI) is a cumulative indicator of the overall competitiveness of an oil and gas asset, based upon efficiency and effectiveness of its performance. It is a numerical value representing the percentage deviation of performance, relative to the corresponding industry or peer group average. For example, if a particular asset has a JHI equal to 10, this would indicate that its performance is 10% better than the average performer. If the calculated JHI is a negative number, it indicates that the performance is worse than the average industry standard. The spread of the Index is not restricted by lower or upper limits (i.e. −100% to +100%). Nevertheless, extremely high deviations have not been observed due to the cumulative nature of the Index.

Efficiency measures the degree to which an organization operates with a minimum consumption of resources. It reflects productivity and is expressed in terms of money, time or effort expended. In contrast, effectiveness measures the degree to which an organization achieves its goals and meets the needs and requirements of its stakeholders. It is result oriented and relates to process and product quality.

The efficiency part of the JHI comprises eight areas that are dually represented, by 16 cost and hour KPIs. These include: business overhead; operations; maintenance; annualized maintenance; health, safety, security and environment (HSSE); technical support; and energy. Facility specific items are also included which comprise activities such as inspection (for pipelines), planning and scheduling (for marine terminals), and laboratory (for processing terminals). A “paired approach” is applied to these areas, which signifies that each of the eight business areas is evaluated not only on the base of costs but also on man hours expended (with the exception of energy where instead of hours, usage in kilogram-joules (KGJ) is employed). By considering man hours expended as well as costs provides a more precise estimation of efficiency and compensates for geographical variations in labor costs.

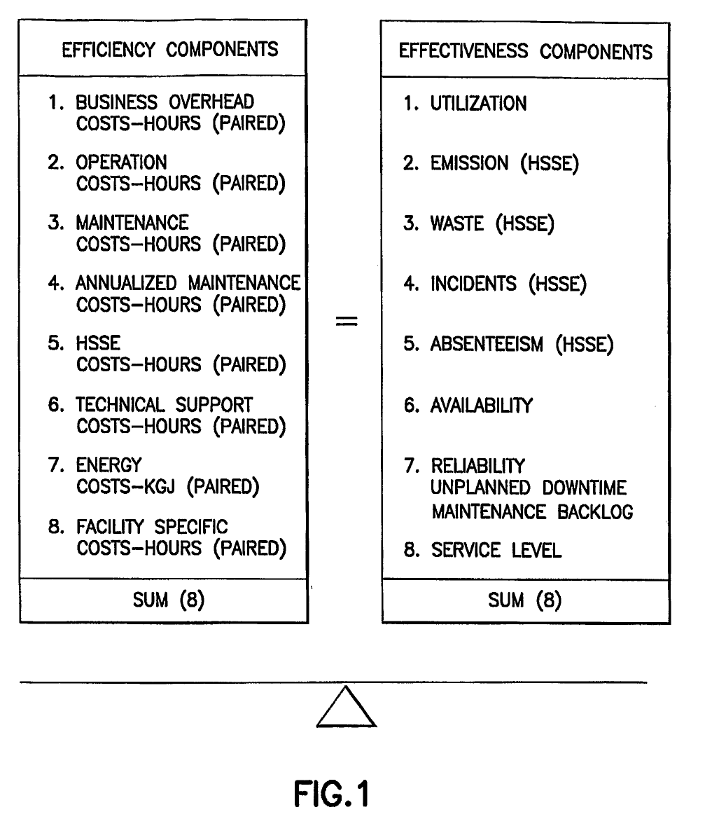

In a similar fashion, the effectiveness element of the JHI embodies five areas of business performance, comprising a total of eight components: utilization, HSSE (represented by 4 measures unrelated to costs and hours), availability, reliability, and service level. FIG. 1 provides a better picture of the index composition and the relationship between various metrics.

The invention considers that the efficiency and effectiveness performances have equal importance for the overall performance as oil and gas companies of today and tomorrow not only must be profitable but must also be customer oriented and socially responsible. The latter have long-term implications and encompass important issues including care for the environment, local communities, and worker safety. This balanced approach is appropriate as no assumptions are made regarding the superiority of one element over the other, and therefore any bias or subjectivity is removed.

In the JHI, most performance metrics of an individual facility are normalized by its corresponding complexity factor. This approach allows “like for like” comparisons of performance indicators of business processes which at first glance may appear too dissimilar for any valid comparison to be made. The Juran Complexity Factor is an overall measurement of the complexity of the facility's routine operations and maintenance, calculated from the standard description of its equipment. In normalizing the key performance metrics, the actual values for a facility are divided by its overall complexity factor. The result is “normalized” performance indicators showing the facility competitiveness per unit of complexity.

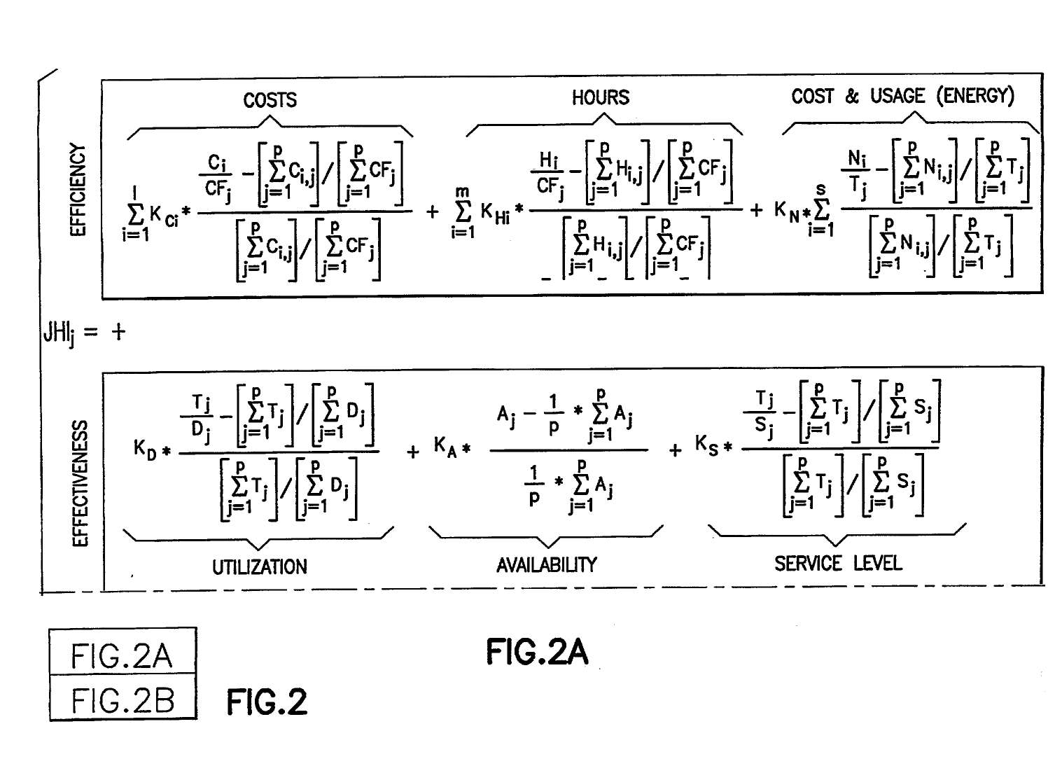

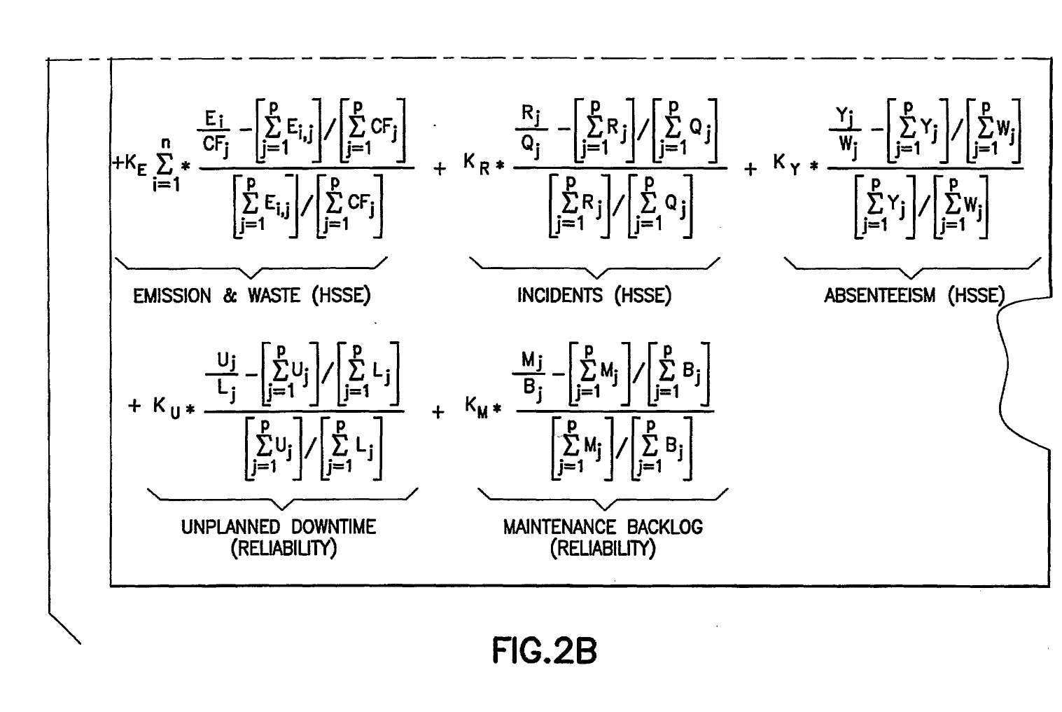

The formula presented in FIG. 2 reveals the elements and calculations which form the basis of the JHI. Essentially, the formula calculates the percentage deviation of each metric from the industry (peer group) average and then, having taken account of the gap coefficient for a particular metric, aggregates all formed values.

Below are some comments associated with FIG. 2:

Gap Coefficients—measure the gap direction and significance

K_{C}—Costs gap coefficient

K_{H}—Hours gap coefficient

K_{N}—Energy gap coefficient

K_{D}—Utilization gap coefficient

K_{A}—Availability gap coefficient

K_{S}—Service Level gap coefficient

K_{E}—Emission & Waste gap coefficient

K_{R}—Incidents gap coefficient

K_{T}—Absenteeism gap coefficient

K_{U}—Unplanned Downtime gap coefficient

K_{M}—Maintenance Backlog gap coefficient

Main Metrics

| | | |
|---|---|---|
| C - Cost Metrics | 7 metrics | Efficiency |
| | (l = 7) | |
| H - Hour Metrics | 7 metrics | Efficiency |
| | (m = 7) | |
| N - Energy Metrics | 2 metrics | Efficiency |
| | (s = 2) | |
| E - Emission & Waste | 2 metrics | Effectiveness |
| | (n = 2) | |
| A - Availability | 1 metric | Effectiveness |
| R - Recordable Incidents | 1 metric | Effectiveness |
| Q - Total Hours | 1 metric | Effectiveness |
| Y - Absent Days Own Staff | 1 metric | Effectiveness |
| W - Days Attributed to Own Staff | 1 metric | Effectiveness |
| U - Unplanned Downtime Hours | 1 metric | Effectiveness |
| L - Total Hours Available | 1 metric | Effectiveness |
| B - Total Maintenance Hours Available | 1 metric | Effectiveness |
| M - Actual Maintenance Hours | 1 metric | Effectiveness |
| S - Actual Demand | 1 metric | Effectiveness |
| D - Design Capacity | 1 metric | Effectiveness |
| T - Total Throughput | 1 metric | Effectiveness |

CF - Complexity Factor of a facility based on standard description of its
equipment
l = m (the total number of costs metrics = the total number of hours
metrics)
p - Sample Size

Costs—encompass all major OPEX costs normalized by complexity (CF):
Business Overheads
Operations
Maintenance
Annualized Maintenance
Health, Safety, Security & Environment
Technical Support
Facility Specific (Laboratory; Inspection; Planning and Scheduling)

Hours—KPIs related to hours have the same division as per facility costs.

Energy—energy costs and usage normalized by total throughput.

Utilization—calculated by dividing the total real throughput by the design capacity.

Health, Safety, Security, and Environment:
Emission: Environment Impact Units (gas flared and vented/CF)
Waste: Total Waste by Complexity (tones/CF)
Incidents: Total Number of Recordable Incidents per million man hours
Absenteeism: Total Own Staff Absenteeism (% of total days)

Service Level—reflects the percentage of overall demand met.

Availability—number of hours that product movement has been restricted due to unavailability of equipment.

Reliability—it is a sum of unplanned downtime (number of hours of unplanned downtime of a system over the total number of hours available) and maintenance backlog (number of maintenance hours in a system over the total number of maintenance hours available).

The structure of the JHI formula ensures a balanced model with equal significance attributed to efficiency and effectiveness of performance. The total number of efficiency business elements is equal to the total number of effectiveness components (8), although the former comprises 16 paired comparators. Where applicable, metrics are normalized by asset complexity to reflect the individual differences between the facilities being benchmarked. Finally, p represents the sample size, indicating the number of participating benchmark facilities used as a basis for the comparisons.

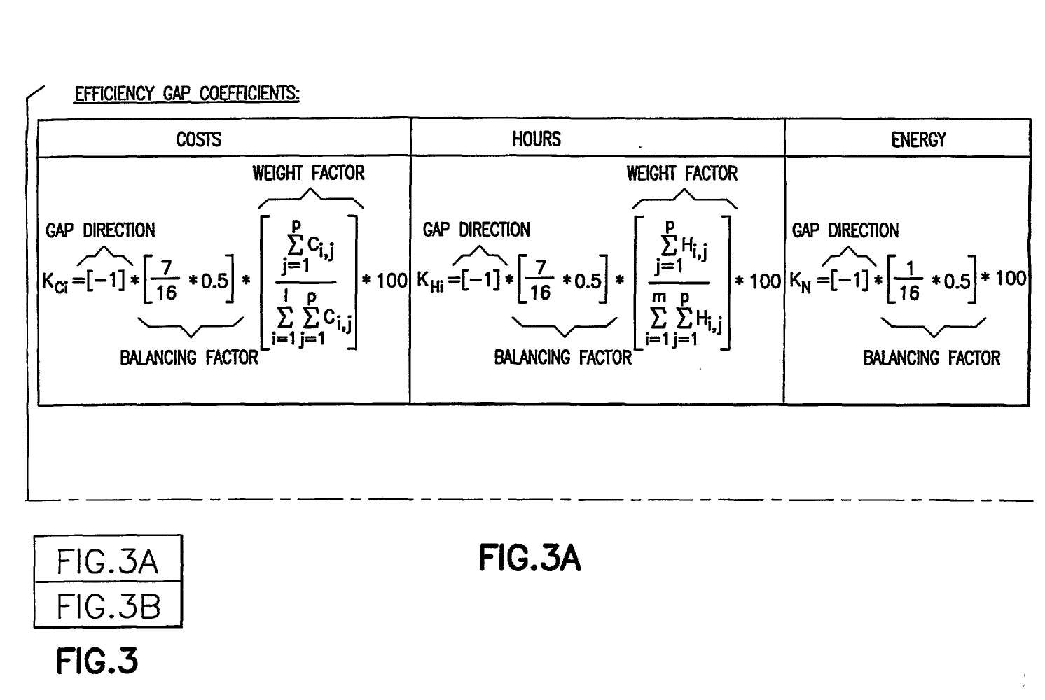

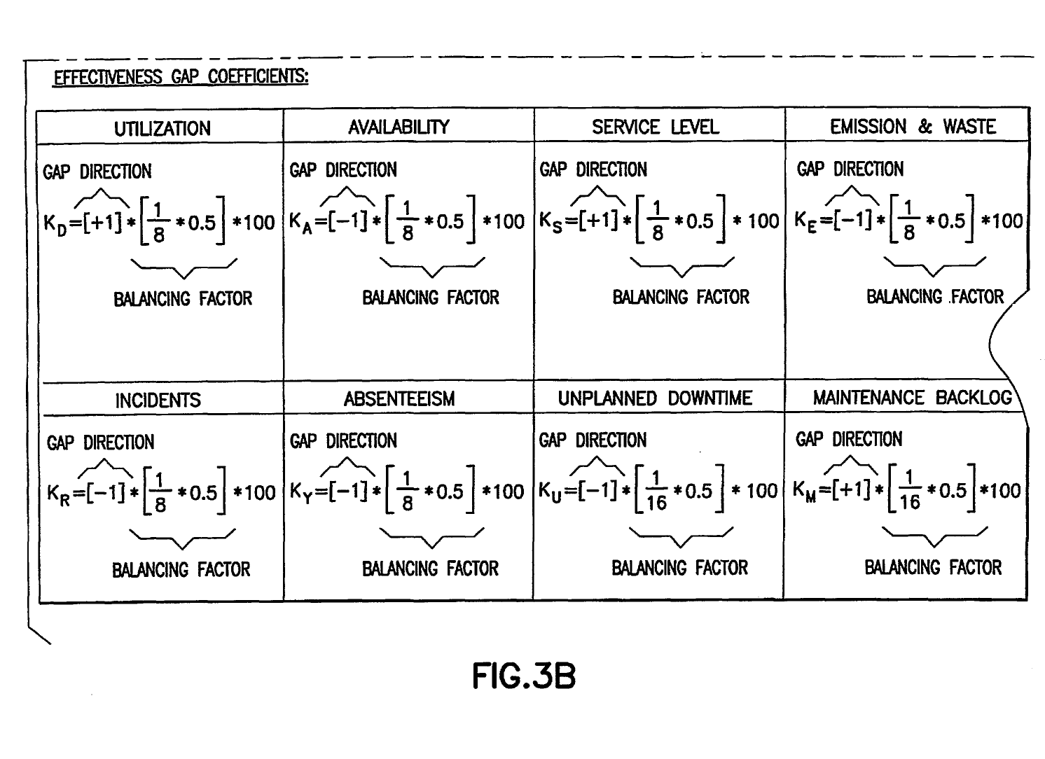

The gap coefficients represent an important element of the JHI in fine tuning the entire performance equation. Their main purpose is threefold: to determine the gap direction; to ensure the balance between efficiency and effectiveness; and to assign the weight of importance to each individual performance measurement. The exact calculation of the gap coefficients is provided in FIG. 3. It should be stressed that all metrics have a weight factor as a part of their gap coefficient. However for some metrics this is equal to one and therefore is not visible in the calculations. For the efficiency gap coefficients (except energy) the weight factors are calculated as weighted averages representing the proportional distribution of each metric in the total sum of cost/hours for a given sample.

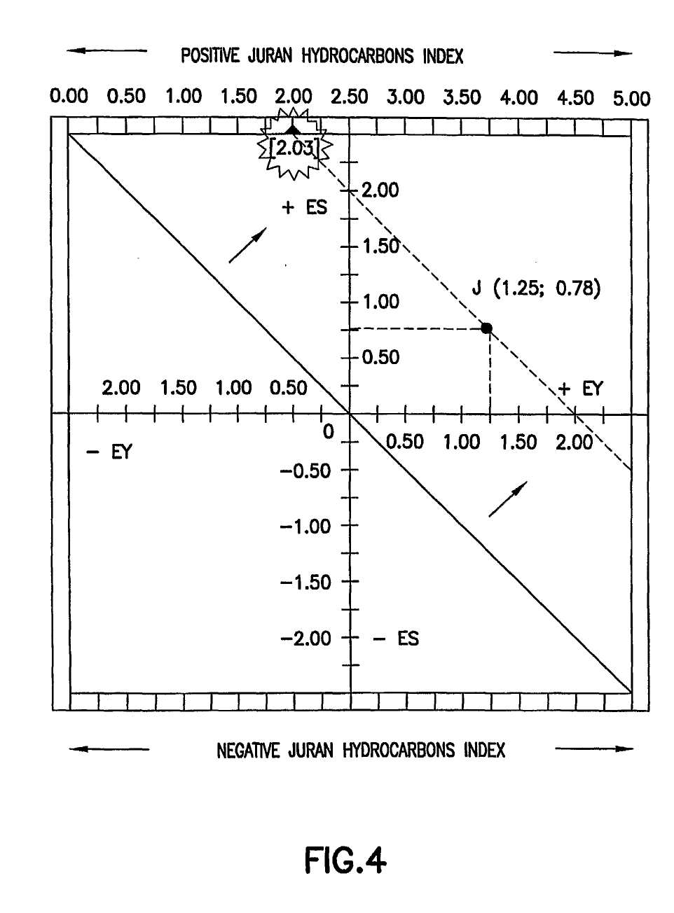

The JHI is graphically presented on a performance matrix that consists of two axes (efficiency (EY) and effectiveness (ES)) and four quadrants. (See FIG. 4.) The solid diagonal line signifies all combinations of EY and ES that are equal to the industry (peer group) overall performance. The slope of the line is 45 degrees, due to the Index balance between the efficiency and effectiveness. This implies that 1% decrease in EY can be compensated by 1% increase in ES, and visa versa. All combinations below the solid diagonal line will be indicative of a performance below the industry average whereas those above it will indicate above average performance. The upper right quadrant is the desired area for a hydrocarbons asset to be, where both EY and ES are positive. The matrix has two scales that measure the Index score: positive (top) and negative (bottom). Point J is a typical example of a well-performing facility. Its index score is 2.03 (i.e. intersection of the dotted diagonal line with the positive index scale).

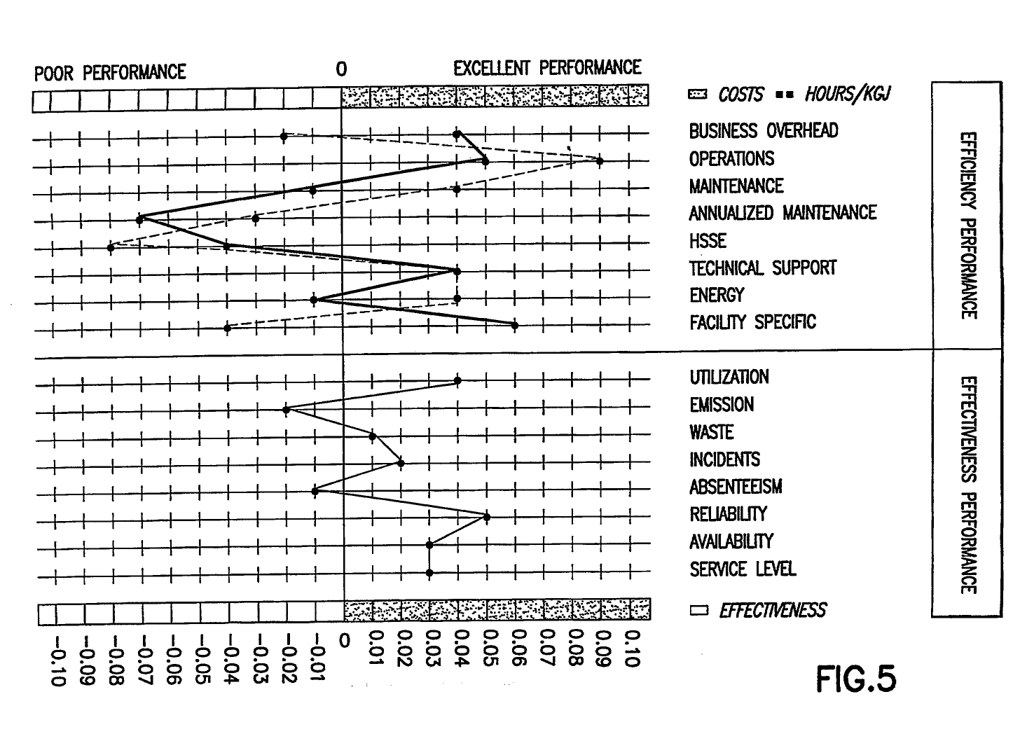

To enable a more detailed analysis, the JHI can be further decomposed. FIG. 5 provides an overview of the competitiveness within each business area. The figure pinpoints the weaknesses (points on the left from the vertical zero line), where improvements need to take place, and the strengths (points on the right from the vertical zero line), where a given company has a competitive edge. It is a performance dashboard that managers can utilize in pursuing their business objectives. For example, it reveals that company J is underperforming in the following efficiency areas: business overhead hours (2%); maintenance costs (1%); annualized maintenance costs (7%) and hours (3%); HS(S)E costs (8%) and hours (4%); energy costs (1%); and facility specific hours (4%). Similarly, its weaknesses in terms of effectiveness relate to emissions (2%) and absenteeism (1%).

JHI Example with a Step-By-Step Computation

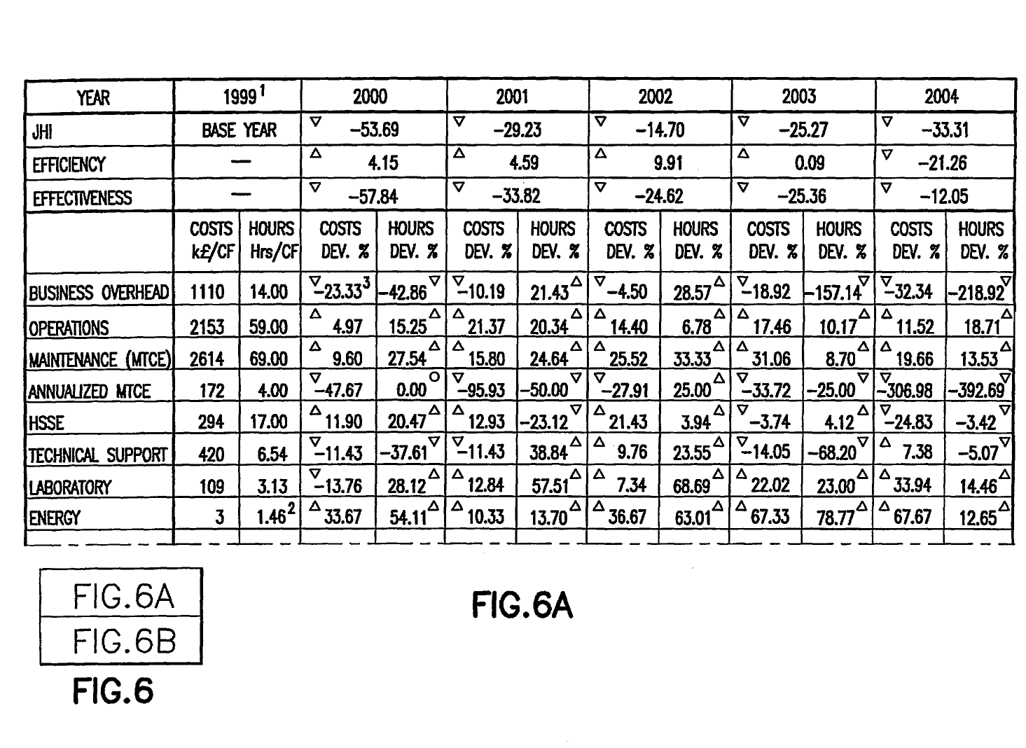

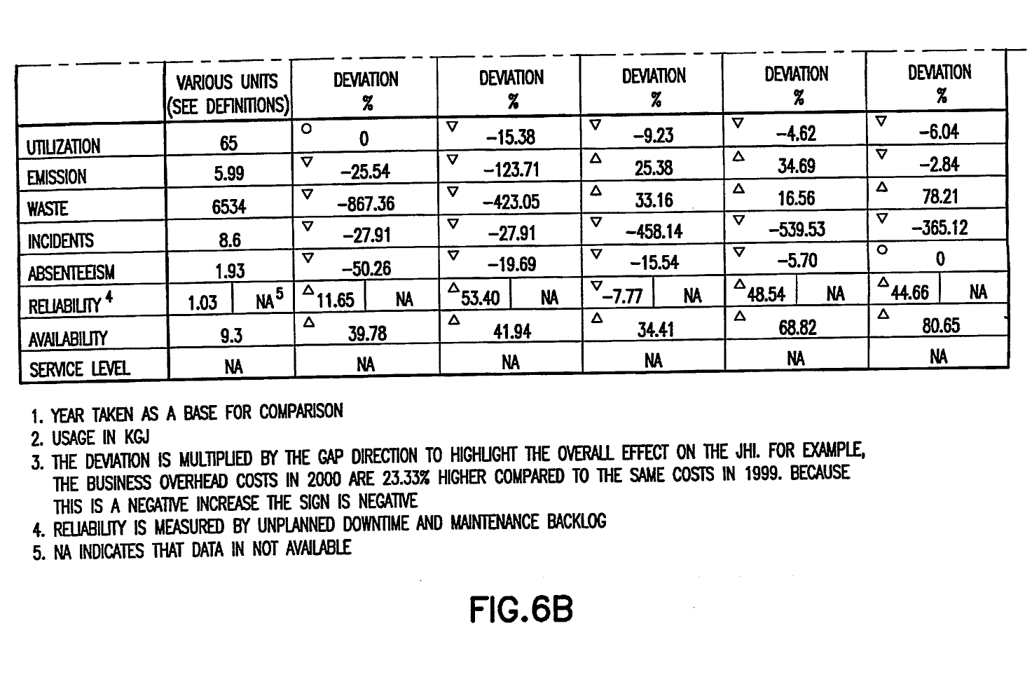

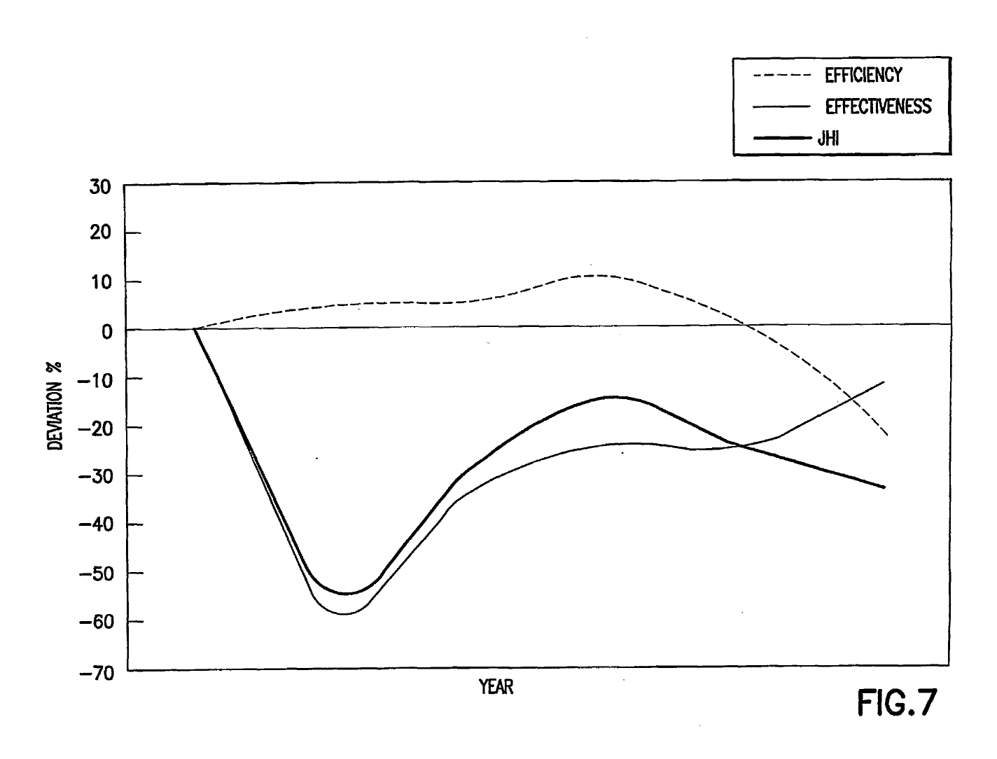

FIG. 6 provides an example showing the annual performance of a large international consortium of processing terminals (25 gas and liquid processing plants across Europe, USA, the Middle East and Asia). The figure indicates that, despite the gains in efficiency between 2000 and 2003, the overall performance of the consortium did not improve in this period (the JHI scores are negative for each year), owing to a decrease in effectiveness that was greater than the gains in the efficiency. Similarly, the consortium performance in 2004 was negative in both efficiency and effectiveness areas. Nevertheless, the effectiveness performance showed signs of improvement in 2004. Closer inspection of the effectiveness element reveals that utilization incidents and absenteeism have had a negative impact on the overall effectiveness performance. Waste and emissions also had for a negative impact in 2000 and 2001 but improved in 2002, 2003 and 2004. The only elements of effectiveness to improve over the time period were availability and reliability (except in 2002). In parallel, overall efficiency was positive between 2000 and 2003 due to the dual reductions (costs & hours) in the operation, maintenance, energy and laboratory activities but decreased in 2004. Business overhead and annualized maintenance performances imposed a negative impact during the entire 5 year period. The trend of JHI dynamics during the time span studied can clearly be seen in FIG. 7.

A step-by-step computation regarding the complete JHI calculation for this industry example, presented in FIGS. 6 and 7, is provided below. All calculations are performed on computer equipments such as a personal computer.

### 1. A Base-Year Selection

Year 1999 is selected as a point of reference so that subsequent yearly performances can be measured. The time span of the analysis is 6 years, from 1999 to 2004.

2. Industry Average Values

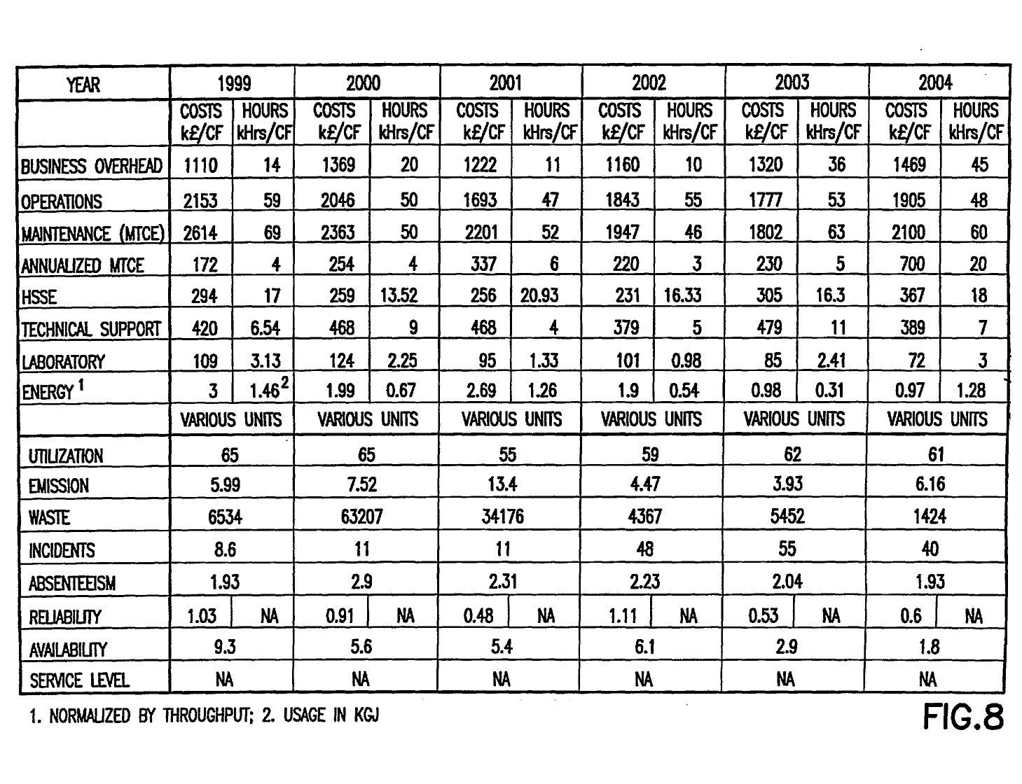

The industry average values for each KPI for a given year are calculated by taking the individual values of all participants in this year. FIG. 8 provides a summary of all average numbers used in the JHI calculation.

3. Percentage Deviations

The percentage deviation for each performance area (KPI) is calculated as a ratio with a numerator expressing the difference between the current-year and the base-year average performance and a denominator representing the base-year average performance. For example, the percentage deviation of “Business Overhead” in year 2004 is equal to: (1469−1110)/1110=0.3234=32.34%. (See FIG. 8 for reference.) The deviation calculations of all other KPIs are analogical.

### 4. Gap Coefficients

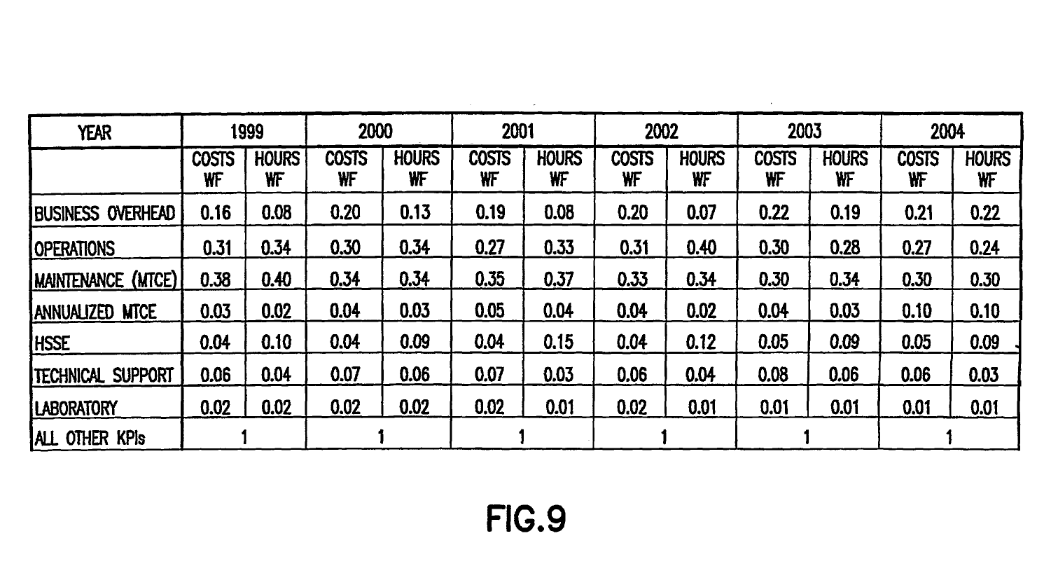

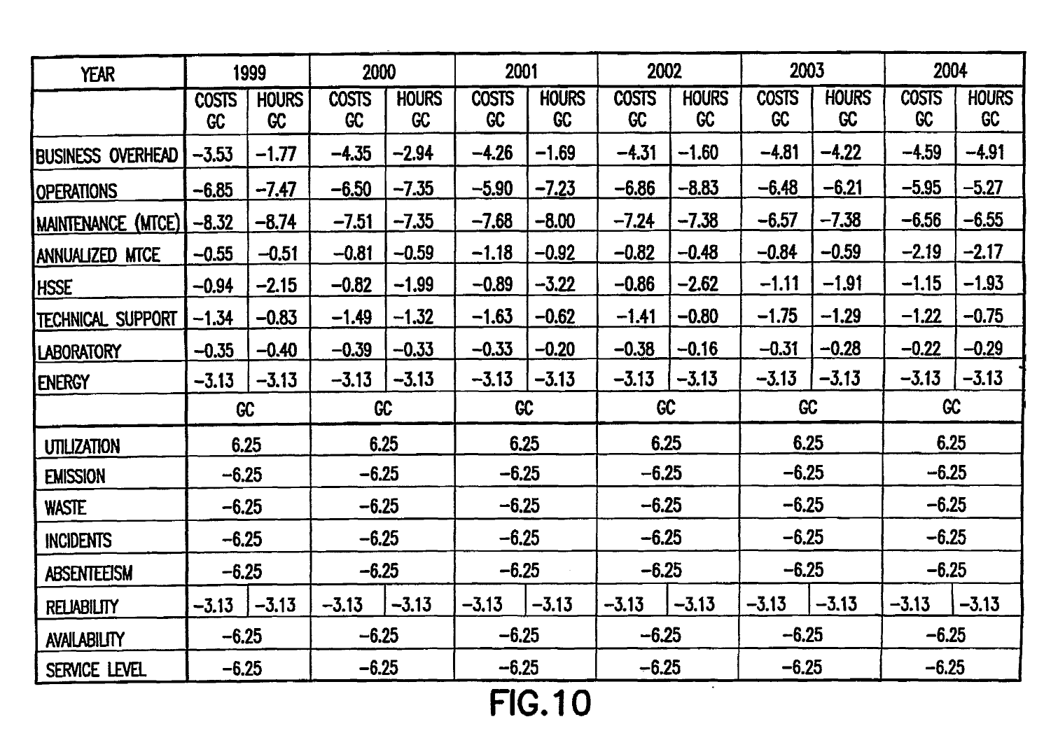

As stated, the gap coefficients consist of 3 parts: a gap direction, a balancing factor and a weight factor. The exact computation of the gap directions and the balancing factors were provided in FIG. 3, which also revealed the general formula for the weight factors. FIG. 9 below presents the exact values of the applied weight factors, whereas FIG. 10 displays the total values of the gap coefficients.

### 5. Efficiency and Effectiveness Scores

The efficiency and effectiveness scores are aggregations of all corresponding KPI deviations multiplied by their gap coefficients. For example, the efficiency score in 2004 can be calculated as follows:

EY=−21.26=0.3234*(−4.59)+(−0.1152)*(−5.95)+(−0.1966)*(−6.56)+3.0698*(−2.19)+0.2483*(−1.15)+(−0.0738)*(−1.22)+(−0.3394)*(−0.22)+(−0.6767)*(−3.13)+2.1892*(−4.91)+(−0.1871)*(−5.27)+(−0.1353)*(−6.55)+3.9269*(−2.17)+0.0342*(−1.93)+0.0507*(−0.75)+(−0.1446)*(−0.29)+(−0.1265)*(−3.13)

Similarly, the effectiveness score in 2004 equals:

ES=−32.11=(−0.0604)*6.25+0.0284*(−6.25)+(−0.7821)*(−6.25)+3.6512*(−6.25)+0*(−6.25)+(−0.4466)*(−3.125)+(−0.8065)*(−6.25)

### 6. Overall JHI Score

The overall JHI score is a summation of efficiency and effectiveness scores. To complete the example above, the JHI value for year 2004 is a result of the following calculation:

JHI₀₄=EY+ES=−21.26+(−12.05)=−33.31

The JHI for year 2000, 2001, 2002 and 2003 are calculated in the exact same fashion.

### 7. Adjustments Based on the JHI Score

Based on the JHI score, alterations can be made to the hydrocarbons operations to increase overall performance thereof.

Thus, it can be seen from the foregoing specification and attached drawings that the method of the present invention provides an effective way to measure overall competitiveness of hydrocarbons operations in order to provide a guideline for altering and improving the same.

It is believed that the many advantages of this invention will now be apparent to those skilled in the art. It will also be apparent that a number of variations and modifications may be made therein without departing from its spirit and scope. Accordingly, the foregoing description is to be construed as illustrative only, rather than limiting. This invention is limited only by the scope of the following claims.

1. A method for measuring overall performance of hydrocarbons operations in a single numerical index to determine whether to make alterations to the hydrocarbons operations comprising the steps of:
(a) providing an industry average;
(b) calculating a single numerical index which is an aggregation of the effectiveness and efficiency of the hydrocarbons operations based on percentage deviation from the industry average; and
(c) altering the hydrocarbons operations based on the single numerical index to increase overall performance thereof.

2. The method of claim 1, wherein during the calculating step a plurality of effectiveness and efficiency variables are used for a specific hydrocarbons industry.

3. The method of claim 2, wherein during the calculating step a balance is achieved between the effectiveness and efficiency variables.

4. The method of claim 1, further comprising the step of computing gap coefficients used during the calculating step.

5. The method of claim 4, wherein the gap coefficients are used to determine gap direction, ensure a balance between efficiency and effectiveness and assign a weight of importance to individual performance measurements.
